(19) United States
(12) Patent Application Publication
(10) Pub. No.: US 2016/0062039 A1
(43) Pub. Date: Mar. 3, 2016

(54) MODE SIZE CONVERTERS AND OPTICAL ASSEMBLIES

(71) Applicant: Tyco Electronics Corporation, Berwyn, PA (US)

(72) Inventors: Haipeng Zhang, Newark, CA (US); Jibin Sun, Redwood City, CA (US); John Wasserbauer, Castro Valley, CA (US); Sandeep Razdan, Millbrae, CA (US); Mark Ostasiuk, Newark, CA (US); Nicola Pugliano, Redwood City, CA (US)

(21) Appl. No.: 14/475,482

(22) Filed: Sep. 2, 2014

(51) Int. Cl. G02B 6/14; G02B 1/04; G02B 6/26; G02B 6/30

(52) U.S. Cl. CPC G02B 6/14; G02B 6/305; G02B 1/045; G02B 6/264; G02B 2006/12061

(57) ABSTRACT

One aspect of the invention provides a mode size converter having a first end and a second end. The mode size converter includes: a silicon waveguide having an inverse taper from the first end; and a silicon nitride waveguide having an inverse taper relative to the first end. The silicon nitride waveguide is adjacent and substantially parallel to the silicon waveguide. Another aspect of the invention provides an optical assembly including: a mode size converter as described herein; and a fiber optic optically coupled to the silicon nitride waveguide at the second end of the mode size converter.

### BACKGROUND

Although significant progress has been made in the fields of silicon-compatible optical interconnect and information processing technology, low loss coupling between optical fiber and high-index contrast single-mode silicon nano-wire waveguide remains a challenge. Mode mismatch between a single-mode silicon wire waveguide and a standard single-mode (SM) fiber depicted in FIG. 1 is so large that it induces high coupling loss.

### SUMMARY OF THE INVENTION

One aspect of the invention provides a mode size converter having a first end and a second end. The mode size converter includes: a silicon waveguide having an inverse taper from the first end; and a silicon nitride waveguide having an inverse taper relative to the first end. The silicon nitride waveguide is adjacent and substantially parallel to the silicon waveguide.

This aspect of the invention can have a variety of embodiments. The inverse taper of the silicon waveguide can grow from about 0.12 micrometers to about 0.35 micrometers. The silicon nitride waveguide can taper from a width of about 1 μm at the first end to between about 0.6 μm and 0.7 μm at the second end.

The silicon nitride waveguide can taper from a width of about 1 μm at the first end to about 0.7 μm over a first distance, then from about 0.7 μm to about 0.67 μm over a second distance. The first distance can be about 280 μm and the second distance can be about 180 μm.

The silicon nitride waveguide can have a height about 200 nm. The silicon waveguide can have a height of about 145 nanometers. The silicon waveguide can have a refractive index n=2.0.

The mode size converter can further include a polymer waveguide adjacent and substantially parallel to the silicon nitride waveguide. The polymer waveguide can comprise SU-8 or a polyimide. The polymer waveguide can have a refractive index n=1.56 or n=1.57. The polymer waveguide can have a height of about 8 μm and a width of about 8 μm.

The mode size converter can further include a cladding surrounding the silicon waveguide and the silicon nitride waveguide between the first end and the second end.

Another aspect of the invention provides an optical assembly including: a mode size converter as described herein; and a fiber optic optically coupled to the silicon nitride waveguide at the second end of the mode size converter.

Another aspect of the invention provides a mode size converter having a first end and a second end. The mode size converter includes: a silicon waveguide having an inverse taper from the first end adapted and configured for optical coupling with a light source having a first cross-sectional dimension; and a high numerical aperture fiber spliced to a tapered tip of the silicon waveguide.

This aspect of the invention can have a variety of embodiments. The high numerical aperture fiber can be fusion spliced to the tapered tip of the silicon waveguide. The high numerical aperture fiber can have a core diameter of about 1.8 μm. The high numerical aperture fiber can have a core diameter of about 9 μm. The tapered tip of the silicon waveguide can have a width of about 120 nm.

The mode size converter can further include a single mode optical fiber coupled to the high numerical aperture fiber. The single mode optical fiber can have a core diameter of about 3 μm. The single mode optical fiber can be fusion spliced to the high numerical aperture fiber.

Another aspect of the invention provides a mode size converter having a first end and a second end. The mode size converter includes: a silicon waveguide having an inverse taper from the first end adapted and configured for optical coupling with a light source having a first cross-sectional dimension; a polymer waveguide substantially parallel to the silicon waveguide; and a high numerical aperture fiber optically coupled to the polymer waveguide.

This aspect of the invention can have a variety of embodiments. The high numerical aperture fiber can have a core diameter of about 1.8 μm. The high numerical aperture fiber can have a core diameter of about 3 μm.

The mode size converter can further include a single mode optical fiber coupled to the high numerical aperture fiber. The single mode optical fiber can have a core diameter of about 9 μm. The single mode optical fiber can be fusion spliced to the high numerical aperture fiber.

Another aspect of the invention provides a mode size converter having a first end and a second end. The mode size converter includes: a silicon waveguide having an inverse taper from the first end adapted and configured for optical coupling with a light source having a first cross-sectional dimension; a single mode optical fiber proximate to and substantially coaxial with a tapered tip of the silicon waveguide; and an optical element interposed between the tapered tip of the silicon waveguide and the single mode optical fiber. The optical element can be selected from the group consisting of: a gradient index coating, a graded index fiber, a ball lens, and a self-written polymer waveguide.

This aspect of the invention can have a variety of embodiments. The gradient index coating can include a plurality of dielectric layers applied to the tip of the single mode optical fiber. The single mode optical fiber can have a core diameter of about 9 μm.

### DESCRIPTION OF THE FIGURES

For a fuller understanding of the nature and desired objects of the present invention, reference is made to the following detailed description taken in conjunction with the figure wherein:

FIG. 1 depicts the mode mismatch between silicon wire waveguides and standard single-mode optical fibers;

FIG. 2 depicts a mode size converter according to an embodiment of the invention;

FIG. 3 depicts a mode size converter according to an embodiment of the invention;

FIG. 4 depicts a mode size converter according to an embodiment of the invention;

FIGS. 5A-5C depict a mode size converters according to embodiments of the invention;

FIG. 6 depicts a mode size converter according to an embodiment of the invention; and

FIG. 7 depicts a mode size converter according to an embodiment of the invention.

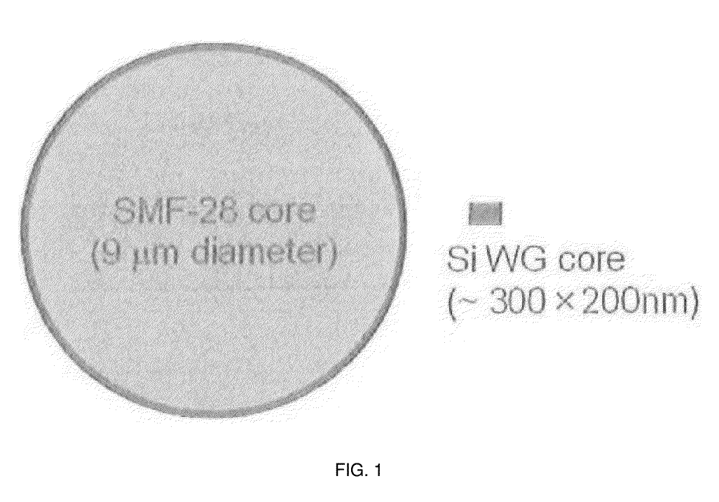

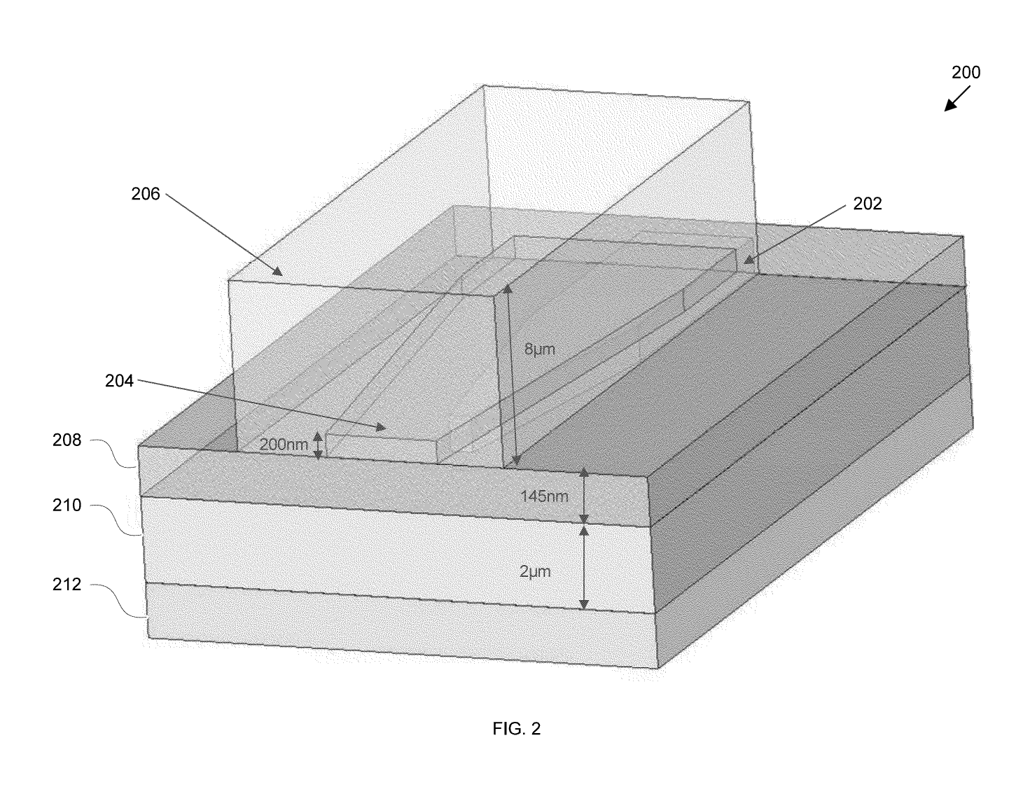

### DETAILED DESCRIPTION

Aspects of the invention provide mode size converters. Such aspects are particularly useful for chip-to-fiber coupling in silicon photonics devices and reduce optical coupling loss due to mode mismatch between silicon nano-wire waveguide and standard single-mode fiber effectively. Aspects of the invention can be fabricated/assembled in an automated and cost-effective way, and have potential to reduce overall cost of photonic integrated circuits packaging.

### Mode Size Converters Incorporating Inverse Taper Silicon and Silicon Nitride Waveguides

One aspect of the invention provides a mode size converter 200 including a silicon waveguide 202 having an inverse taper from a first end, a silicon nitride (Si₃N₄) waveguide 204 having an inverse taper from the first end, the silicon nitride waveguide substantially parallel to the silicon waveguide 202, and a polymer waveguide 206 applied over the silicon nitride waveguide.

The inverse taper of the silicon waveguide 202 can grow from about 0.12 μm to about 0.35 μm over about a taper length of about 50 μm.

The tapered silicon nitride waveguide 204 can be deposited on top of the silicon waveguide. The tapered silicon nitride waveguide 204 can have a height of about 0.2 μm. In one embodiment, the silicon nitride waveguide 204 first tapers from about 0.67 μm to about 0.7 μm over a taper length of about 180 μm, then tapers from about 0.7 μm to about 1 μm over a taper length of about 280 μm.

Fundamental transverse (TE) mode in the silicon waveguide 202 will be adiabatically transferred into the silicon nitride waveguide 204 through the inversed silicon taper structure first. Silicon nitride waveguide 204 can have a refractive index (n) of about 1.98 or 2.00.

A polymer waveguide 306 (e.g., SU-8 with n=1.57, or ULTRADEL 9120D with n=1.56) can be applied over silicon nitride waveguide 304. (The chemical structure of ULTRADEL 9120D is provided in Y. Liu, Investigation of Polymer Waveguides for Fully Embedded Board-level Optoelectronic Interconnects (May 2004) (Ph.D. dissertation, The University of Texas at Austin), available at http://repositories.lib.utexas.edu/handle/2152/2072.) Polymer waveguide 306 can have a width of about 8 μm and a height of about 8 μm in order to be mode matched to single mode fiber (SMF-28). Optical mode that was transferred from silicon waveguide to silicon nitride waveguide will then be transferred into the polymer waveguide through the nitride waveguide taper, and eventually coupled to single mode fiber.

An outer cladding (e.g., a cladding having a refractive index n of about 1.5 or about 1.54. Suitable materials include EPO-TEK® OG113 epoxy available from Epoxy Technology, Inc. of Billerica, Mass. and ULTRADEL 9020D polyimide, the chemical structure of which is provided in T.C. Kowalczyk et al., Guest-Host Crosslinked Polyimides for Integrated Optics (1995), available at http://www.osti.gov/scitech/biblio/94010 and Y. Liu, Investigation of Polymer Waveguides for Fully Embedded Board-level Optoelectronic Interconnects (May 2004) (Ph.D. dissertation, The University of Texas at Austin), available at http://repositories.lib.utexas.edu/handle/2152/2072.

The silicon waveguide 202 and silicon nitride waveguide 204 can be formed on top of one or more substrates. For example, the silicon waveguide 202 can be embedded within an oxide layer 208. In one embodiment, oxide layer 208 has a height of about 145 nm. Oxide layer 208 can be formed over a buried oxide (BOX) layer 210, which can have a thickness of about 2 μm and a refractive index n=1.45. BOX layer can be formed over a silicon handle wafer 212. Silicon handle wafer 212 can have a refractive index n=3.50.

This mode size converter scheme can be fabricated through CMOS (complimentary metal-oxide-semiconductor) compatible processing to ensure low cost, and will be especially useful in silicon photonics chips that use nitride layer as upper cladding of Si waveguide.

Embodiments of converter 200 achieve a coupling length of 500 μm and a coupling efficiency of greater than 85% (88% in some embodiments) with a 2 dB tolerance around +/−2 μm.

### Mode Size Converters Incorporating Inverse Tapers and High Numerical Aperture (NA) Fibers

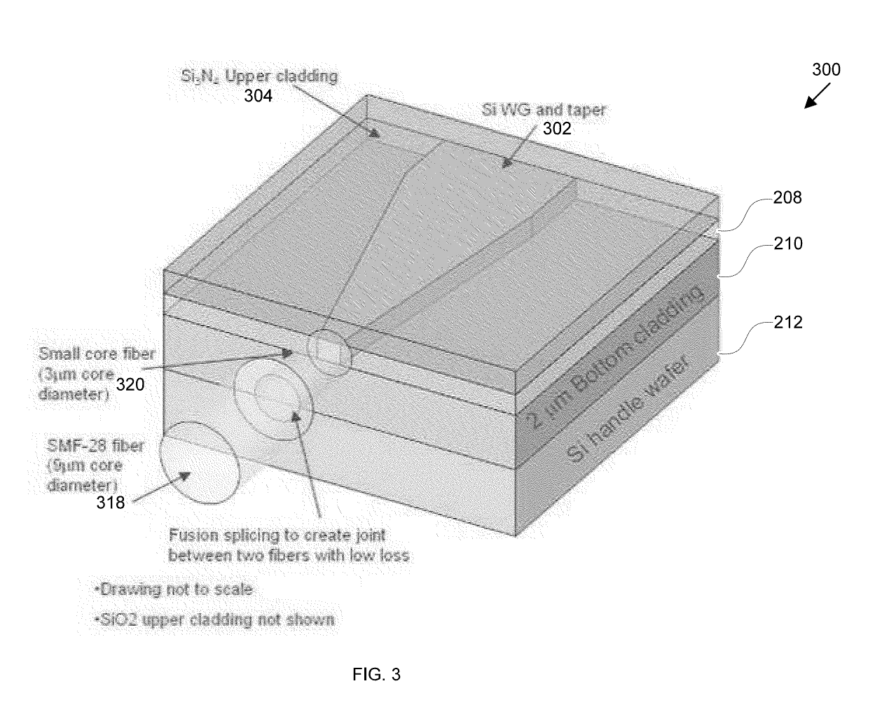

Referring now to FIG. 3, another aspect of the invention provides still another mode size converter 300 based on a silicon waveguide 302 having an inverse taper and a combination of high numerical aperture (NA) fiber 320 (e.g., having a core diameter of about 3 μm) and a single mode fiber 318 (e.g., SMF-28 fiber having a 9 μm core). The high NA fiber 320 can have a numerical aperture (NA) of about 0.35, a core diameter of about 1.8 μm, and a field diameter of about 3.3 μm at a wavelength of about 1310 nm. Suitable high NA fiber 320 is available under model number UHNA3 from Nufern of East Granby, Conn.

An inversed taper first expands the mode in the silicon waveguide 302. Due to limited cladding thickness of the silicon waveguide 302 structure, the mode field diameter at the inversed taper tip can not be expanded large enough to match a SMF-28 fiber. This aspect of the invention applies a small-core, high NA, single mode fiber 320 with up to 3 μm core diameter to first match the mode of the inversed taper.

Silicon waveguide 302 can terminate in a tip having a width of about 120 nm.

The small-core fiber 320 can be connected to a standard single mode fiber (SMF-28) 318 by fusion splicing. By applying multiple sparks, the fused region between two fibers will form a relatively smooth transition region that can reduce transition loss. This design provides a cost-effective way to convert mode size from a silicon nano-wire waveguide with relatively thin cladding to a SMF-28 fiber, without the added complication of modifying the waveguide structure itself.

Embodiments of this aspect of the invention provide improved coupling efficiency, a short spot size converter (SSC), and relatively simple fabrication. Additionally, nitride layer etching is not required.

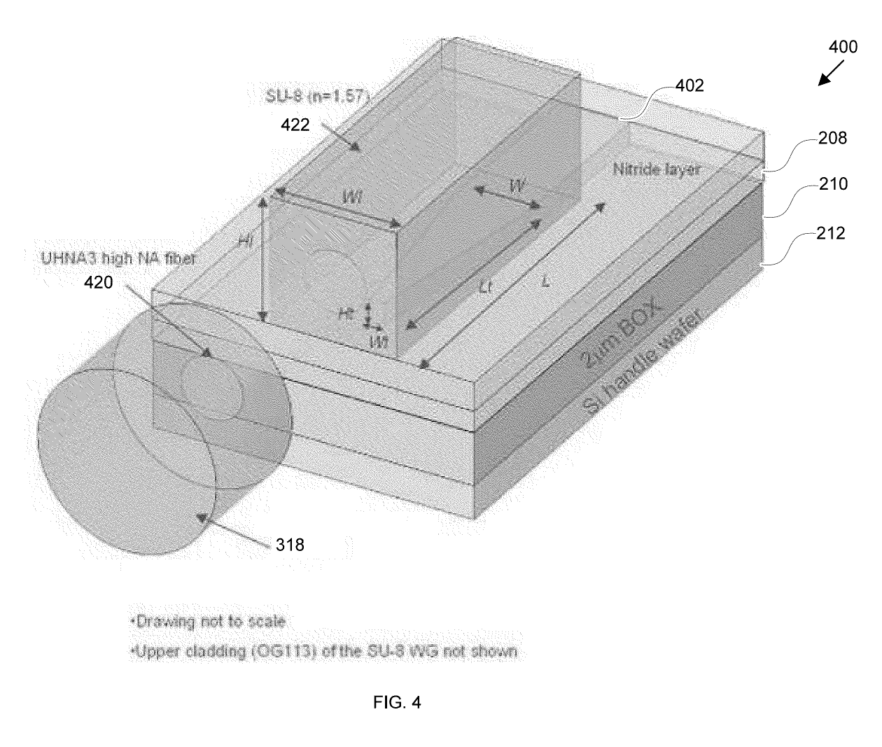

Referring now to FIG. 4, another aspect of the invention interposes a low index waveguide 422 (e.g., a waveguide having a suitable refractive index between about 1.45 and about 1.6) between silicon waveguide 402 and high NA fiber 420.

The low index waveguide 422 can be fabricated from a polymer such as SU-8 and can have a refractive index n=1.57. In one embodiment, the low index waveguide 422 can have a width WI of about 3 μm, a height HI of about 3 μm, and a length L of about 220 μm.

The silicon waveguide 402 can have a tapered width Wt of about 120 nm, from a taper length Lt of about 170 μm. (Other dimensions for silicon waveguide 402 can be as described herein.)

Embodiments of this invention achieve 89% coupling (0.5 dBM loss) with a 2 dBm tolerance around ±0.9 μm. Embodiments of this aspect of the invention provide improved coupling efficiency, use a short spot size converter (SSC), and avoid direct contact between the tip of the silicon waveguide 402 taper with the high NA fiber 420. Additionally, nitride layer etching is not required.

### Mode Size Converters Incorporating Gradient Index (GRIN) Coatings

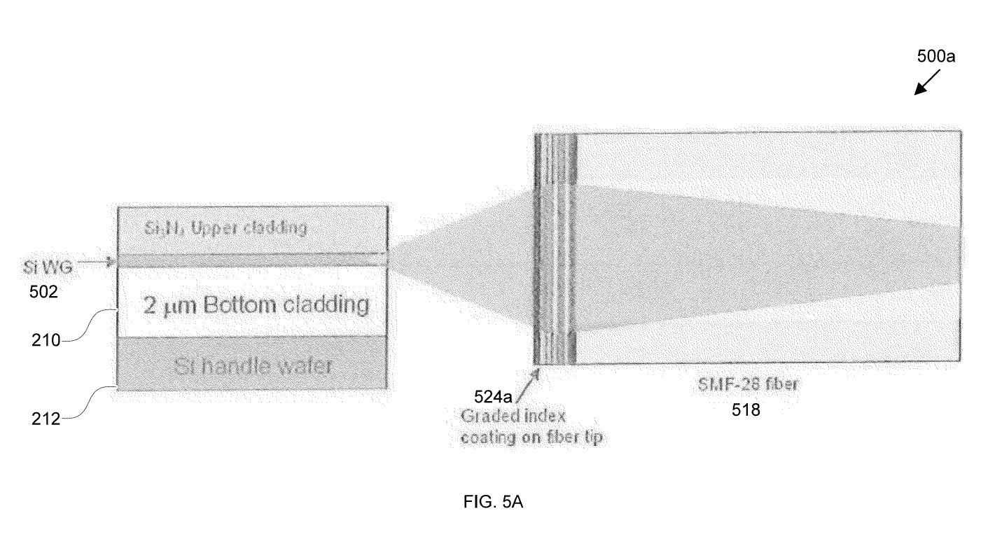

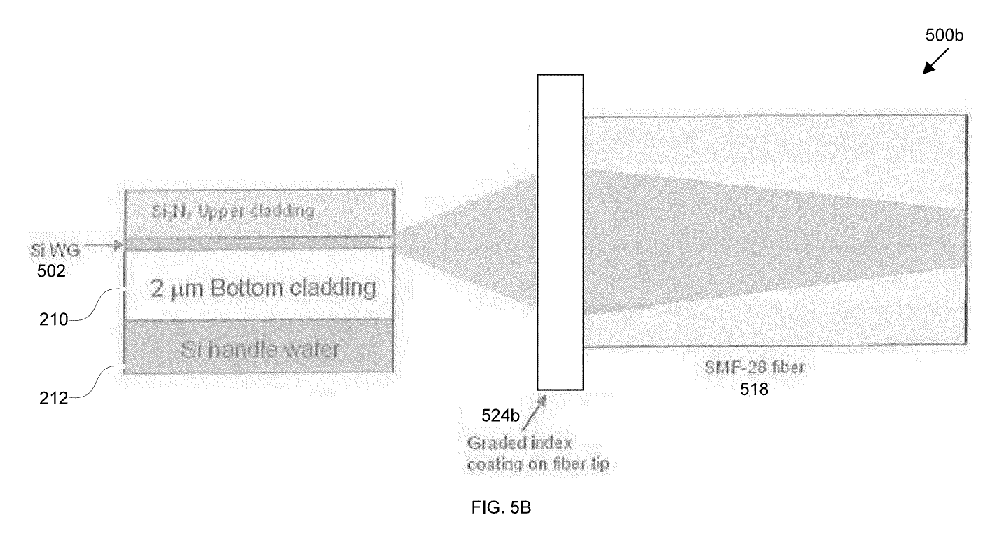

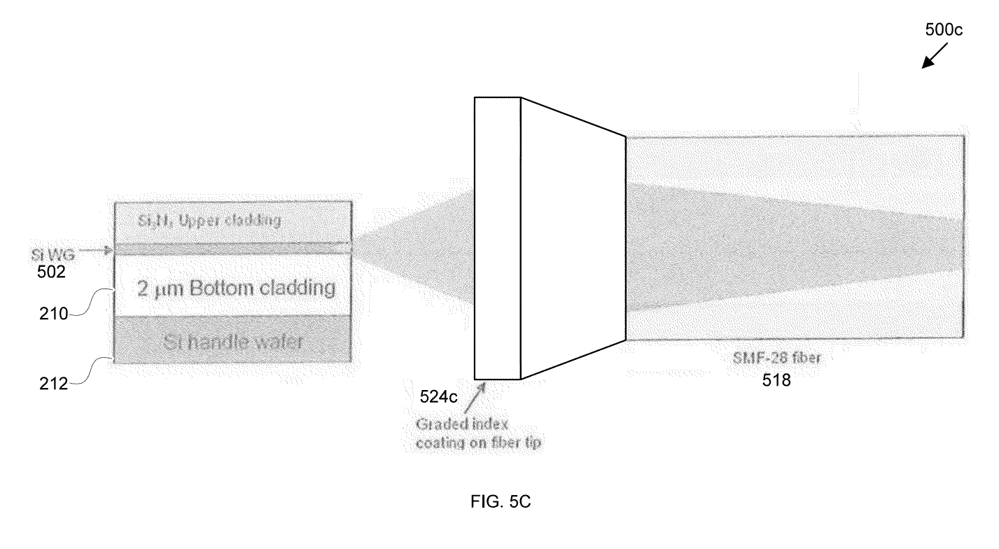

Referring now to FIGS. 5A-5C, another aspect of the invention provides a mode size converter 500 between a silicon waveguide 502 and a single mode fiber 518 (e.g., SMF-28) using a gradient index (GRIN) coating 524a (e.g., a silica coating) or a graded index fiber 524b, 524c.

Light confined in a typical silicon waveguide will diverge quickly once exiting the confinement region.

Referring to FIG. 5A, multiple layers of dielectric material 524 with specially designed refractive index contrast will act like a GRIN lens 524a on a fiber tip, and the diverged light can be coupled into the fiber 518 with reduced insertion loss. The layer closest to the silicon waveguide will typically have the highest refractive index.

Referring to FIGS. 5B and 5C, a graded index fiber can either have an abrupt or tapered interface, respectively.

### Mode Size Converters Incorporating Ball Lenses

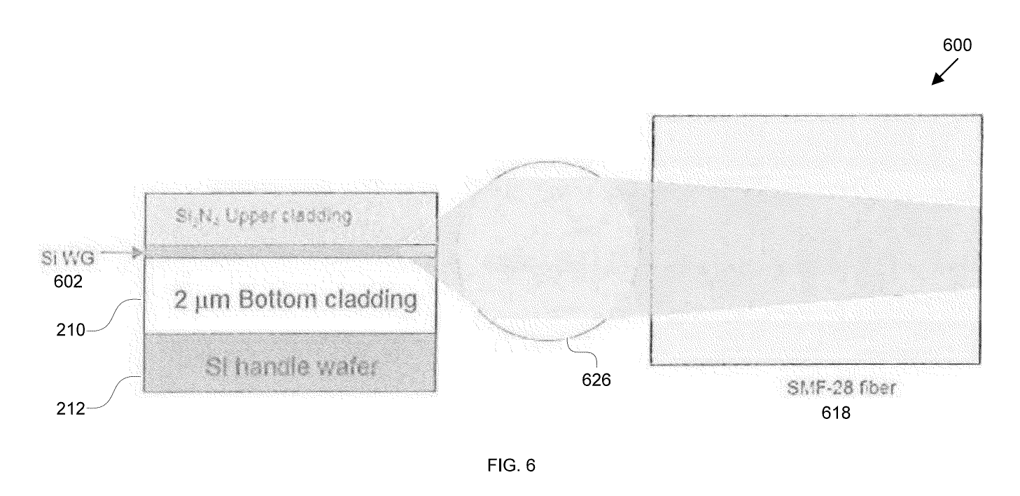

Referring now to FIG. 6, another aspect of the invention provides a similar mode size conversion 600 to that presented in FIG. 5, but instead of using a potentially-costly GRIN coating 524, a silica ball lens 626 is applied to collimate the beam from silicon waveguide 602 using its front surface, and refocus the beam into the single mode fiber 618 using its back surface. Both the lens and the fiber can be accurately aligned in either a V-groove or a trench.

### Mode Size Converters Incorporating Self-Written Polymer Waveguides

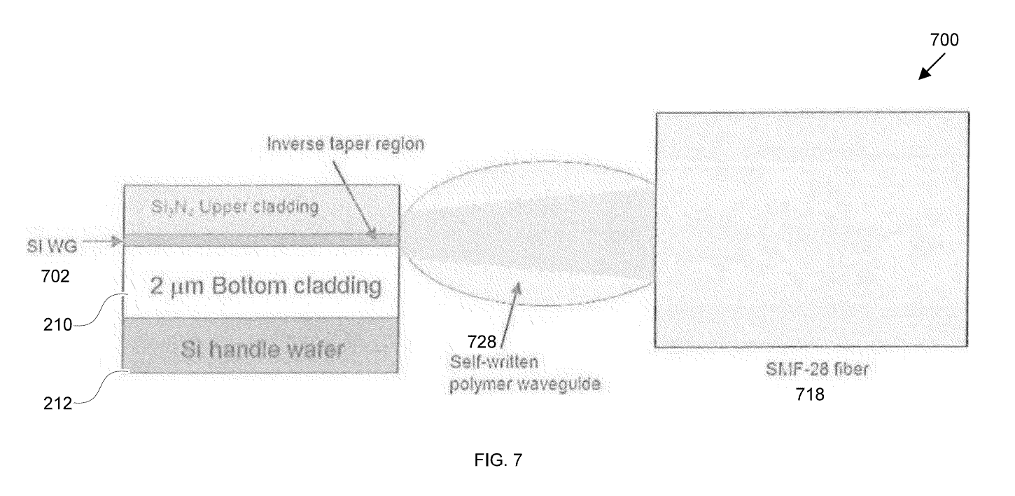

Referring now to FIG. 7, another aspect of the invention provides a mode size converter 700 coupling a silicon waveguide 702 to fiber 718 utilizing self-written polymer waveguide material 728 (available from Norland Products of Cranbury, N.J.). By applying UV curable resin 728 between the silicon waveguide 702 and the optical fiber 718, and launching UV light from both directions, a mode matching region will be created in the polymer material 728 that can reduce coupling loss between the silicon waveguide 702 and the fiber 718. To achieve better coupling, the silicon waveguide 702 can include an inversed taper structure as described and depicted herein.

### EQUIVALENTS

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules and the like) shown as distinct for purposes of illustration can be incorporated within other functional elements, separated in different hardware, or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

1. A mode size converter having a first end and a second end, the mode size converter comprising:
a silicon waveguide having an inverse taper from the first end; and
a silicon nitride waveguide having an inverse taper relative to the first end, the silicon nitride waveguide adjacent and substantially parallel to the silicon waveguide.

2. The mode size converter of claim 1, wherein the inverse taper of the silicon waveguide grows from about 0.12 micrometers to about 0.35 micrometers.

3. The mode size converter of claim 1, wherein the silicon nitride waveguide tapers from a width of about 1 μm at the first end to between about 0.6 μm and 0.7 μm at the second end.

4. The mode size converter of claim 1, wherein the silicon nitride waveguide tapers from a width of about 1 μm at the first end to about 0.7 μm over a first distance, then from about 0.7 μm to about 0.67 μm over a second distance.

5. The mode size converter of claim 4, wherein the first distance is about 280 μm and the second distance is about 180 μm.

6. The mode size converter of claim 1, wherein the silicon nitride waveguide has a height about 200 nm.

7. The mode size converter of claim 1, wherein the silicon waveguide has a height of about 145 nanometers.

8. The mode size converter of claim 1, wherein the silicon waveguide have a refractive index n=2.0.

9. The mode size converter of claim 1, further comprising:
a polymer waveguide adjacent and substantially parallel to the silicon nitride waveguide.

10. The mode size converter of claim 9, wherein the polymer waveguide comprises SU-8 or a polyimide.

11. The mode size converter of claim 9, wherein the polymer waveguide has a refractive index n=1.56 or n=1.57.

12. The mode size converter of claim 9, wherein the polymer waveguide has a height of about 8 μm and a width of about 8 μm.

13. The mode size converter of claim 1, further comprising:
a cladding surrounding the silicon waveguide and the silicon nitride waveguide between the first end and the second end.

14. An optical assembly comprising:
the mode size converter of claim 1; and
a fiber optic optically coupled to the silicon nitride waveguide at the second end of the mode size converter.

15. A mode size converter having a first end and a second end, the mode size converter comprising:
a silicon waveguide having an inverse taper from the first end adapted and configured for optical coupling with a light source having a first cross-sectional dimension; and
a high numerical aperture fiber spliced to a tapered tip of the silicon waveguide.

16. The mode size converter of claim 15, wherein the high numerical aperture fiber is fusion spliced to the tapered tip of the silicon waveguide.

17. The mode size converter of claim 15, wherein the high numerical aperture fiber has a core diameter of about 1.8 μm or about 9 μm.

18. The mode size converter of claim 15, wherein the tapered tip of the silicon waveguide has a width of about 120 nm.

19. A mode size converter having a first end and a second end, the mode size converter comprising:
a silicon waveguide having an inverse taper from the first end adapted and configured for optical coupling with a light source having a first cross-sectional dimension;
a polymer waveguide substantially parallel to the silicon waveguide; and
a high numerical aperture fiber optically coupled to the polymer waveguide.

20. A mode size converter having a first end and a second end, the mode size converter comprising:
a silicon waveguide having an inverse taper from the first end adapted and configured for optical coupling with a light source having a first cross-sectional dimension;
a single mode optical fiber proximate to and substantially coaxial with a tapered tip of the silicon waveguide; and
an optical element interposed between the tapered tip of the silicon waveguide and the single mode optical fiber, the optical element selected from the group consisting of: a gradient index coating, a graded index fiber, a ball lens, and a self-written polymer waveguide.
